(19) United States
(12) Patent Application Publication
(10) Pub. No.: US 2024/0173689 A1
(43) Pub. Date: May 30, 2024

(54) REACTOR AND METHOD FOR PRODUCING SAME

(71) Applicant: L'Air Liquide, Société Anonyme pour l'Etude et l'Exploitation des Procédés Georges Claude, Paris (FR)

(72) Inventors: Tobias OELMANN, Bad Vilbel (DE); Michael STROZYK, Offenbach (DE); Wolfgang MAY, Frankfurt am Main (DE); Timm SCHUHMANN, Bensheim (DE)

(21) Appl. No.: 18/517,026

(22) Filed: Nov. 22, 2023

(30) Foreign Application Priority Data
Nov. 25, 2022 (EP) 22209668.7

(51) Int. Cl. B01J 19/24; B01J 19/00

(52) U.S. Cl. CPC B01J 19/249; B01J 19/0053; B01J 2219/185; B01J 2219/2462; B01J 2219/2493

(57) ABSTRACT

A reactor having a reactor vessel and, inside the reactor vessel there is a plate assembly which is mounted upright, a distributor which is attached to the plate assembly, at least one supply line, via which the distributor is connected to a respective cooling fluid inlet of the reactor vessel, and a collector which is attached to the plate assembly, at least one discharge line, via which the collector is connected to a respective cooling fluid outlet of the reactor vessel. Wherein flow paths for the cooling fluid are formed, and wherein the at least one discharge line is curved in such a way that the discharge line runs around an axis of the reactor vessel by at least 180°.

### CROSS REFERENCE TO RELATED APPLICATIONS

This application claims the benefit of priority under 35 U.S.C. § 119 (a) and (b) to European Patent Application No. EP 22209668.7, filed Nov. 25, 2022, the entire contents of which are incorporated herein by reference.

### BACKGROUND

The invention relates to a reactor and to a method for producing such a reactor. The reactor can be used in particular for methanol synthesis.

For applications such as methanol synthesis, what are referred to as pillow plate reactors are known. In the latter, a chemical reaction can be carried out under cooling. For this purpose, pillow plate reactors have an assembly of pillow plates through which a cooling medium flows. A catalyst can be arranged between the pillow plates, with a reaction gas being able to be conducted along said catalyst. This allows the reaction gas to be converted. Meanwhile, the reaction gas can be cooled by the cooling medium which flows inside the pillow plates. The cooling medium can be introduced into the pillow plates via a distributor and discharged from the pillow plates via a collector. The distributor and the collector are usually integrated in a cooling circuit via supply lines and/or discharge lines.

During operation, components of a pillow plate reactor may sometimes expand significantly. Not all the components have the same coefficient of expansion and not all the components are exposed to the same temperature. Therefore, the individual components of a pillow plate reactor usually expand to differing extents. This can lead to stresses and ultimately even to damage. In particular, the reactor jacket of a pillow plate reactor may expand differently than the plate assembly. This can lead to significant stresses in lines via which the cooling medium is conducted to the pillow plates and away from the pillow plates.

Due to the pressures which have to be taken into account, a flexible solution using a flexible hose is possible only with a great outlay, if it is possible at all.

The problems described also occur in the case of reactors which, although similar to a pillow plate reactor, cannot be considered as such according to the definition of the concept pillow plate reactor.

It is the object of the present invention to reduce the effects of thermal expansion in a reactor in a simple manner.

### SUMMARY

These objects are achieved by a reactor and a method according to the independent claims. Further advantageous embodiments are specified in the dependent claims. The features presented in the claims and in the description may be combined with one another in any technologically meaningful way.

The invention presents a reactor. The reactor comprises a reactor vessel. Furthermore, the reactor comprises the following elements, each of which is arranged inside the reactor vessel:
a plate assembly which is mounted upright and which is formed by a plurality of cooling plates through which a cooling fluid can flow, wherein between the cooling plates intermediate spaces, in which a catalyst is arranged, are formed such that a reaction gas can flow through the intermediate spaces and come into contact with the catalyst,
a distributor which is attached to the plate assembly on an underside of the plate assembly,
at least one supply line, via which the distributor is connected to a respective cooling fluid inlet of the reactor vessel,
a collector which is attached to the plate assembly on a top side of the plate assembly,
at least one discharge line, via which the collector is connected to a respective cooling fluid outlet of the reactor vessel,

wherein flow paths for the cooling fluid are formed, the flow paths in each case leading from one of the cooling fluid inlets through the corresponding supply line, the distributor, one of the cooling plates, the collector and one of the discharge lines to the corresponding cooling fluid outlet, wherein the at least one discharge line is curved in such a way that the discharge line runs around an axis of the reactor vessel by at least 180°.

A reactor is a device which is designed to carry out a chemical reaction. The reactor described is preferably designed for methanol synthesis. However, it is not important for the operation and advantages of the reactor described below for which chemical reaction the reactor is actually designed and used. The reactor described can be used for a multiplicity of conceivable chemical reactions, in which a reaction gas is converted with a catalyst under cooling.

The reactor comprises a reactor vessel. The reactor vessel is preferably designed as a pressure vessel. The reactor vessel preferably comprises a reactor jacket, which may also be referred to as a pressure jacket. Inside the reactor vessel, a reaction gas can be chemically converted under pressure. For example, the reaction gas can be introduced via a reaction gas inlet into an interior of the reactor vessel, can be chemically converted in the interior of the reactor vessel and can be discharged from the reactor vessel through a reaction gas outlet. The chemical reaction occurring inside the reactor vessel means that the reaction gas generally has a different chemical composition at the reaction gas outlet than at the reaction gas inlet. In the case of methanol synthesis, the reaction gas is preferably a synthesis gas, which is formed on the one hand from carbon monoxide and/or carbon dioxide and on the other hand from hydrogen.

A catalyst is arranged inside the reactor vessel. The catalyst can initiate and/or accelerate the chemical reaction. The reaction gas can be conducted past the catalyst inside the reactor vessel. By selection of the catalyst material, the reactor can be designed for a specific chemical reaction. In the case of methanol synthesis, the catalyst is preferably a copper-zinc catalyst.

The reaction gas can be cooled inside the reactor vessel, in particular during the chemical reaction. This is particularly expedient in the case of an exothermic chemical reaction. The cooling can be achieved via a plate assembly which is formed by a plurality of cooling plates. The cooling plates are preferably arranged parallel to one another and spaced apart from one another in such a way that intermediate spaces form between the cooling plates. The catalyst is preferably arranged within said intermediate spaces. This allows the reaction gas to flow through the intermediate spaces between the cooling plates and to be brought into contact there with the catalyst.

Cooling via the cooling plates is possible by a cooling fluid flowing through the cooling plates. The cooling fluid can be liquid or gaseous. Preferably, the cooling fluid is provided in a liquid state and evaporated during cooling. The cooling fluid is preferably H₂O. Use of the chemical sign H₂O is intended to make it clear that the cooling fluid can also be present in a gaseous form. This means that the cooling fluid can be water or water vapour. In the case of H₂O as the cooling fluid, the cooling fluid may also be referred to as boiler feed water when it is introduced into the reactor. The cooling fluid may be present as vapour when it exits the reactor. However, the described cooling function generally does not depend either on the chemical composition or on the state of matter of the cooling fluid.

The cooling plates through which the cooling fluid can flow each have at least one cooling channel, within which the cooling fluid can flow through the cooling plates. The cooling channel can have several branches. For example, the cooling plates can each be formed by two sheets being connected to each other at a plurality of connection points, for example by welding points. The connection points are preferably distributed over the surface of the cooling plate, in particular at regular intervals, so that the connection points form a grid. Between the connection points, the cooling fluid can flow between the sheets. To facilitate this, the sheets can be bent in such a way that there is contact between the sheets only at the connection points. Outside the connection points, the at least one cooling channel is formed between the sheets.

The cooling plates designed as described may also be referred to as pillow plates. The reactor described may be correspondingly referred to as a pillow plate reactor. However, it may depend on what precisely is included in the definition of a pillow plate or a pillow plate reactor. In this context, the reactor is essentially defined by the explicitly specified features, irrespective of these terms.

The plate assembly is mounted upright. When mounted upright, the plate assembly is mounted on an underside of the plate assembly. For example, the plate assembly may be placed onto supports on the underside. Since the plate assembly is mounted upright, the plate assembly thermally expands upwards.

The counterpart to the described upright mounting of the plate assembly is suspended mounting. The fact that the plate assembly of the described reactor is described as being mounted upright therefore means in particular that the plate assembly of the described reactor is not mounted in suspended form. When mounted in suspended form, the plate assembly is mounted on a top side of the plate assembly. For example, a plate assembly could be mounted in suspended form by the plate assembly being connected to the reactor vessel at the top side via a bracket, in particular via grills. In the case of a plate assembly mounted in suspended form, the plate assembly would thermally expand downwards.

Upright mounting is advantageous in particular at a low vapour production rate compared to the mounting in suspended form. In addition, upright mounting allows optimum use of the ratio of the catalyst space to the vessel space, since there is mechanical support from below for upright mounting.

The elements of the reactor, via which the cooling fluid can be introduced into and discharged from the cooling plates, will be described below.

A distributor is attached to the plate assembly on an underside of the plate assembly. The distributor is connected to a respective cooling fluid inlet of the reactor vessel via at least one supply line. The cooling fluid can thus be introduced into one of the cooling fluid inlets, conducted through the corresponding supply line to the distributor and distributed via the distributor to the cooling plates. For this purpose, the distributor is attached to the cooling channels of the cooling plates. Within the distributor, the cooling fluid is preferably liquid, in particular liquid water.

The reactor can have one or more supply lines. In the case of a single supply line, the supply line connects the single cooling fluid inlet to the distributor. In the case of a plurality of supply lines, each of the supply lines in each case connects a coolant inlet to the distributor. The reactor has precisely one cooling fluid inlet per supply line.

A collector is attached to the plate assembly on a top side of the plate assembly. The collector is connected to a respective cooling fluid outlet of the reactor vessel via at least one discharge line. The cooling fluid can thus be collected from the cooling plates via the collector, conducted through one of the discharge lines to the corresponding cooling fluid outlet and discharged through the latter. For this purpose, the collector is attached to the cooling channels of the cooling plates. The function of the collector is thus inverse to the function of the distributor. Within the collector, the cooling fluid is preferably gaseous, in particular water vapour. The collector may therefore also be referred to as a vapour collector.

The reactor can have one or more discharge lines. In the case of a single discharge line, the discharge line connects the single cooling fluid outlet to the collector. In the case of a plurality of discharge lines, each of the discharge lines in each case connects a coolant outlet to the collector. The reactor has precisely one cooling fluid outlet per discharge line.

That the distributor is arranged on the underside of the plate assembly and the collector on the top side refers to the orientation of the reactor as intended.

The cooling fluid can be introduced into the corresponding supply line from outside the reactor vessel via the cooling fluid inlet or via the cooling fluid inlets. The cooling fluid can thus pass through a reactor jacket at the cooling fluid inlet or at the cooling fluid inlets. The cooling fluid can be discharged from the corresponding discharge line from the reactor vessel via the cooling fluid outlet or via the cooling fluid outlets. The cooling fluid can thus pass through the reactor jacket at the cooling fluid outlet or at the cooling fluid outlets. However, the cooling fluid enters the interior of the reactor vessel only to the extent that the cooling fluid enters the supply line(s), the distributor, the cooling plates, the collector and the discharge line(s). The cooling fluid does not come into contact with the reaction gas inside the reactor vessel. Between the reaction gas and the cooling fluid there is only heat exchange in the manner of a heat exchanger, especially in the region of the cooling plates.

Flow paths for the cooling fluid are thus formed, the flow paths in each case leading from one of the cooling fluid inlets through the corresponding supply line, the distributor, one of the cooling plates, the collector and one of the discharge lines to the corresponding cooling fluid outlet. In the case of a single supply line, all the flow paths lead together from the one cooling fluid inlet through the supply line to the distributor. In the case of a plurality of supply lines, each of the flow paths leads from one of the cooling fluid inlets through the corresponding supply line to the distributor. In any case, the flow paths are divided in the distributor between the cooling plates. Each flow path passes through precisely one of the cooling plates. The flow paths are collected in the collector. In the case of a single discharge line, all the flow paths lead together from the collector to the one cooling fluid outlet. In the case of a plurality of discharge lines, each of the flow paths leads from the collector to the corresponding cooling fluid outlet.

Outside the reactor vessel, the cooling fluid can be removed from the cooling fluid outlet or from the cooling fluid outlets and cooled. The cooling fluid can then be introduced again into the cooling fluid inlet or into one of the cooling fluid inlets. In this way, a cooling circuit can be formed. The flow paths then lead outside the reactor vessel from the at least one cooling fluid outlet to the at least one cooling fluid inlet, and therefore the flow paths are self-contained. In the case of a cooling circuit, the cooling fluid can therefore be reused in whole or in part. However, this is not required. It is also conceivable for fresh cooling fluid to be always introduced into the at least one cooling fluid inlet and for the cooling fluid removed from the at least one cooling fluid outlet to be disposed of.

The cooling fluid can be cooled outside the reactor vessel with a cooling device. The cooling device is preferably designed as a vapour drum. The cooling device does not have to be part of the reactor described. However, it is preferred that the reactor has a cooling device for cooling the cooling fluid, which is arranged outside the reactor vessel and which is connected on the one hand to the cooling fluid inlet or to the cooling fluid inlets and on the other hand to the cooling fluid outlet or to the cooling fluid outlets. This cooling device is integrated in the flow paths. As an alternative to the use of a separate cooling device, the cooling fluid can also be cooled outside the reactor vessel in the ambient air, for example.

The cooling fluid can be circulated in the cooling circuit without a pump. This is especially possible in the case of water as a cooling medium, because the difference in density between liquid and gaseous water vapour creates natural circulation. This natural circulation is based on the thermosyphon effect. However, it is also conceivable that the cooling circuit has a pump, especially outside the reactor.

All the elements of the reactor that can come into contact with the catalyst are preferably formed from steel, especially from stainless steel. This can prevent the catalyst from attacking the material of these elements. Elements that are in contact with the reactor vessel, on the other hand, are preferably formed from a chromium-molybdenum alloy. Corrosion-resistant steel is particularly preferred, because iron oxide as a catalysed by-product can thus be avoided.

The cooling plates are preferably formed from steel, preferably from stainless steel.

The collector is preferably formed from steel, especially from stainless steel. The discharge line is preferably formed from a chromium-molybdenum alloy and/or from steel, in particular stainless steel. For example, a portion of the discharge line attached to the collector can be formed from steel, while the remaining portion of the discharge line is formed from a chromium-molybdenum alloy. In this way, the two previously described requirements regarding the material can be taken into account. The steel portion attached to the collector is preferably designed as a rectilinear pipe piece, which is oriented in particular parallel to the axis of the reactor vessel. It has been found that such a selected location of the material transfer between the steel and the chromium-molybdenum alloy is particularly advantageous in terms of the flexibility of the discharge line. In order to minimize the effect of the thermal expansion, the range of different materials above the level of the reactor vessel should be kept as small as possible. Furthermore, the material separation should therefore not only preferably be placed as close as possible to the plate assembly, but preferably also in the region of a rectilinear pipe piece. This allows the stress state to be optimized. A material separation in a rectilinear pipe piece is advantageous because a rectilinear pipe piece has a simpler stress state compared to a curved pipe piece. This is true in particular of a rectilinear pipe piece formed parallel to the axis of the reactor vessel, because primarily axial forces instead of shearing forces act in such a pipe piece, in particular in comparison to a pipe piece which is arranged perpendicular to the axis of the reactor vessel.

The distributor is preferably formed from steel, especially stainless steel. The supply line is preferably formed from a chromium-molybdenum alloy and/or from steel, in particular stainless steel. For example, a portion of the supply line attached to the distributor can be formed from steel, while the remaining part of the supply line is formed from a chromium-molybdenum alloy. In this way, the two previously described requirements regarding the material can be taken into account. The steel portion attached to the distributor is preferably designed as a rectilinear pipe piece, which is oriented in particular parallel to the axis of the reactor vessel. It has been found that such a selected location of the material transition between the steel and the chromium-molybdenum alloy is particularly advantageous in terms of the flexibility of the supply line. This is especially true if the material transition is selected to be close to the plate assembly.

The discharge line preferably has a diameter in the range of 2 to 25 cm, in particular in the range of 4 to 15 cm. The supply line preferably has a diameter in the range of 2 to 25 cm, in particular in the range of 4 to 15 cm.

In the reactor described, the effects of thermal expansion are particularly low. This is achieved in that the at least one discharge line is curved in such a way that the discharge line runs around an axis of the reactor vessel by at least 180°, preferably by at least 270°, particularly preferably by at least 360°. Particularly preferably, the at least one discharge line is curved such that the discharge line runs around the axis of the reactor vessel by 360° to 1080°. This means that the discharge line runs around the axis of the reactor vessel once completely to three times completely.

In the case of a single discharge line, this discharge line is curved in such a way that the discharge line runs around the axis of the reactor vessel by at least 180°. In the case of a plurality of discharge lines, the discharge lines are in each case curved in such a way that each of the discharge lines runs around the axis of the reactor vessel by at least 180°. In the case of a plurality of discharge lines, these are each preferably designed in accordance with the preferred embodiments described herein of the one discharge line.

The axis of the reactor vessel extends in a vertical direction. The collector, the plate assembly and the distributor are preferably arranged on the axis of the reactor vessel.

The fact that the discharge line runs around the axis of the reactor vessel completely means that, when projected onto a plane perpendicular to the axis of the reactor vessel, the discharge line encloses the axis of the reactor vessel completely, i.e. on all sides. If the discharge line runs around the axis of the reactor vessel only by 180 to 360°, a corresponding definition applies. In this case, the discharge line does not completely enclose the axis of the reactor vessel, when projected onto a plane perpendicular to the axis of the reactor vessel. In the case of 180°, the discharge line encloses only half of the axis of the reactor vessel, when projected onto a plane perpendicular to the axis of the reactor vessel.

The discharge line does not have to run around the axis of the reactor vessel at a constant distance. In a preferred embodiment, the discharge line is annular or spiral. However, this is not required. In particular, the discharge line may also have rectilinear portions.

Both in the case of an annular and a spiral configuration of the discharge line, a circular form can arise in a projection onto a plane perpendicular to the axis of the reactor vessel. This is the case if the axis of the reactor vessel coincides with an axis of the annular or spiral discharge line. This is preferred.

The fact that the discharge line runs around an axis of the reactor vessel by at least 180° does not state anything about how the discharge line runs in the vertical direction. The beginning and end of the discharge line may be at the same height or may be spaced apart in the vertical direction. Between the beginning and the end, the discharge line can rise, fall or run at a constant height as desired—at least as far as the definition considered here is concerned.

That the discharge line runs around an axis of the reactor vessel by at least 180°, preferably by at least 270°, particularly preferably by 360°, can alternatively also be expressed by the fact that
when viewed in a projection onto a plane perpendicular to an axis of the reactor vessel, an orientation of the discharge line changes over the course of the discharge line by at least 180°, preferably by at least 270°, particularly preferably by 360°, or
when viewed in a projection onto a plane perpendicular to an axis of the reactor vessel, the discharge line runs around the axis of the reactor vessel by at least 180°, preferably by at least 270°, particularly preferably by 360°, or
when viewed in a projection onto a plane perpendicular to an axis of the reactor vessel, the discharge line encloses the axis of the reactor vessel by at least 180°, preferably by at least 270°, particularly preferably by 360°.

The previously described preferred embodiments of the discharge line also apply correspondingly to these alternative formulations.

Regardless of the selected formulation, the effects of thermal expansion are particularly low owing to the described embodiment of the discharge line. Such thermal expansions can in particular cause the beginning and end of the discharge line to shift relative to each other in the vertical direction. The circumferential configuration of the discharge line means that this change in height is distributed over a comparatively large length of the discharge line and thus has a comparatively small effect on the discharge line. In particular, the forces caused by the thermal expansion can be distributed particularly well. This is based on the finding that a length of the discharge line in the case of the described circumferential configuration of the discharge line is longer than in particular in the case of a direct rectilinear connection between collector and cooling fluid outlet. This can be illustrated in particular by means of a spiral discharge line, with a spiral axis coinciding with the axis of the reactor vessel. If the beginning and end of such a spiral discharge line are separated along the axis of the spiral or the reactor vessel, the individual windings of the spiral are pulled apart only comparatively little. For the described operation, however, it is not important for the discharge line to be precisely in the form of a spiral. The same function is also performed in an analogous manner if the discharge line has any shape that meets the definition described. In particular, rectilinear portions of the discharge line adversely affect the described operation, only to a small extent, if at all.

It has been found that the advantages described are already achieved to a reasonable extent when the discharge line runs around the axis of the reactor vessel by 180°. Flexibility is achieved in both a horizontal and a vertical direction. The more the discharge line runs around the axis of the reactor vessel, the greater a length of the discharge line can be. Therefore, the described advantages are achieved to a greater extent the more the discharge line runs around the axis of the reactor vessel. It is therefore preferred for the discharge line to run around the axis of the reactor vessel by at least 270°, in particular even by at least 360°.

Owing to the described design of the discharge line, the effects of thermal expansions can be reduced particularly simply. This is especially true in comparison to flexible solutions with a flexible hose. The described discharge line can be designed as a pipeline. Accordingly, the discharge line can readily withstand even high pressures, which would not be the case, for example, with a hose. Preferably, the discharge line is designed to be able to withstand a pressure of at least 100 bar.

In a preferred embodiment of the reactor, the at least one discharge line is formed with a plurality of rectilinear pipe pieces and at least one curved pipe piece.

As previously described, a particularly low effect of thermal expansion can also be achieved with such a configuration. A configuration with a plurality of rectilinear pipe pieces and at least one curved pipe piece also offers the advantage of being particularly simple to manufacture. This is especially true in comparison to a spiral discharge line. This can most simply be produced in a single bending process. However, this has to be carried out very precisely so that the beginning and end of the discharge line have precisely the desired relative arrangement to each other when the discharge line is completed.

The discharge line of the present embodiment, on the other hand, can be produced by holding the pipe pieces together and connecting them to one another, in particular by welding them together or flanging them on one another. This can be carried out as a multi-step process by means of which the discharge line is gradually obtained. A new adjustment can be undertaken in each step. This can compensate again for any inaccuracy in previous steps.

In addition, it is advantageous if the individual pipe pieces are standard parts. Such pipe pieces are particularly easy to obtain and are inexpensive.

The curved pipe pieces can in particular have an elbow shape. Such a pipe piece is in the shape of a ring segment. The curved pipe piece is preferably curved by 30 to 180°, in particular by 90°. A pipe piece curved by 90° is in the shape of a quarter ring. In particular, such pipe pieces are available as standard parts.

In another preferred embodiment, the reactor has a plurality of the discharge lines, wherein in each case only a portion of the flow paths runs through each of the discharge lines.

It was previously described that the reactor comprises at least one discharge line, via which the collector is connected to a respective cooling fluid outlet of the reactor vessel. In the present embodiment, this is the case in that the reactor comprises at least two of these discharge lines. Particularly preferably, precisely two of the discharge lines are provided.

In each case only a portion of the flow paths runs through each of the discharge lines. The cooling fluid therefore always passes through precisely one discharge line on the way from the collector to one of the cooling fluid outlets, but not through a plurality of the discharge lines in succession.

The discharge lines are dimensioned in such a way that specifications regarding the flow rate and flow velocity of the cooling fluid through the discharge lines can be adhered to. These specifications can be selected in particular in such a way that the cooling fluid can be circulated in the cooling circuit without a pump. These specifications determine the line cross section which all of the discharge lines together have to have. If at least two discharge lines are provided, this overall line cross section is distributed across a plurality of discharge lines. A comparatively small line cross section is therefore sufficient for the individual discharge lines. This is advantageous because a large line cross section generally requires a correspondingly large wall thickness of the discharge line in order to achieve the desired pressure resistance. However, a discharge line with a large wall thickness is less flexible than a discharge line with a smaller wall thickness. Owing to the division into at least two discharge lines, the discharge lines can therefore be particularly flexible, which further contributes to being able to compensate particularly readily for thermal expansions.

The discharge lines are preferably symmetrical to one another. This allows a particularly uniform flow to be achieved.

In another preferred embodiment of the reactor, the at least two discharge lines are curved in the same direction and are attached offset from one another to the collector.

In this embodiment, the at least two discharge lines are arranged in a particularly space-saving manner.

In another preferred embodiment of the reactor, the at least one cooling fluid outlet is arranged spaced apart upwards from the collector.

The fact that the discharge line runs around an axis of the reactor vessel by at least 180° does not state anything about the course of the discharge line in the vertical direction. The beginning and end of the discharge line can be at the same height or be spaced apart from one another in the vertical direction. In the present embodiment, this is now limited to the fact that the beginning and end of the discharge line are spaced apart from each other in the vertical direction. It has been found that this can reduce the effects of thermal expansion even further. If the beginning and end of the discharge line are spaced apart from each other in the vertical direction, it can be easier to achieve a large length of the discharge line than if the beginning and end of the discharge line were at the same height.

In another preferred embodiment of the reactor, the at least one discharge line leaves a clearance free around the axis of the reactor vessel.

Owing to the free space, the plate assembly is particularly easily accessible. Owing to the clearance, in particular the catalyst between the cooling plates can be filled, emptied or replaced particularly simply.

In another preferred embodiment of the reactor, the at least one supply line is curved in such a manner that, when viewed in a projection onto a plane containing the axis of the reactor vessel, an orientation of the supply line in a first portion of the supply line changes over the course of the supply line by at least 135°, preferably by at least 150°, and in a second portion of the supply line, which adjoins the first portion in the direction of the distributor, an orientation of the supply line changes over the course of the supply line by at least 45°, preferably by at least 60°, wherein the at least one supply line is curved in the first portion in the opposite direction to the second portion.

In the present embodiment, the effects of thermal expansion are particularly low. This is achieved by the fact that the supply line is curved as described. It is particularly preferred that the supply line initially runs horizontally, then in the first portion is curved by 180°, then in the second portion is curved in the opposite direction to the first portion by 90° and then runs vertically upwards. The supply line preferably lies in one plane. However, advantages can also be achieved if the course of the supply line deviates from this ideal case. It has been found that advantageous results can be achieved especially when the supply line changes its orientation in the first portion by at least 45°, in particular by 60 to 110°, and in the second portion by at least 135°, in particular by 150 to 210°.

In the case of a single supply line, this supply line is curved as described. In the case of a plurality of supply lines, the supply lines are in each case curved as described.

The axis of the reactor vessel extends in a vertical direction. The collector, the plate assembly and the distributor are preferably arranged on the axis of the reactor vessel.

The described curvature refers to a projection onto a plane containing the axis of the reactor vessel. This does not state anything about how the supply line runs outside this plane. The beginning and end of the supply line can be offset from each other in relation to this plane. However, for the sake of simplicity, it is preferred that the supply line is level. In particular, it is preferred that the supply line is formed within a plane containing the axis of the reactor vessel. This definition ignores the extent of the cross section of the supply line.

The supply line does not have to be curved with a constant radius of curvature. In a preferred embodiment, this is true in the first portion and/or in the second portion. In particular, however, the supply line may also be partially rectilinear in the first portion and/or in the second portion.

That the at least one supply line is curved in such a manner that, when viewed in a projection onto a plane containing the axis of the reactor vessel, an orientation of the supply line in a first portion of the supply line changes over the course of the supply line by at least 135°, preferably by at least 150°, and in a second portion of the supply line, which adjoins the first portion in the direction of the distributor, an orientation of the supply line changes over the course of the supply line by at least 45°, preferably by at least 60°, wherein the at least one supply line is curved in the first portion in the opposite direction to the second portion, can alternatively also be expressed by the fact that
the at least one supply line is curved in a first portion with respect to a first axis of curvature by at least 135°, preferably by at least 150°, and in a second portion, which adjoins the first portion in the direction of the distributor, is curved with respect to a second axis of curvature by at least 45°, preferably by at least 60°, in the opposite direction to the first portion, wherein the first axis of curvature and the second axis of curvature are each perpendicular to a plane containing the axis of the reactor vessel, or
the at least one supply line is curved in such a manner that the supply line runs in a first portion around a first axis by at least 135°, preferably by at least 150°, and in a second portion, which adjoins the first portion in the direction of the distributor, runs around a second axis by at least 45°, preferably by at least 60°, in the opposite direction to the first portion, wherein the first axis and the second axis are each perpendicular to a plane containing the axis of the reactor vessel.

The described preferred embodiments also apply correspondingly to these alternative formulations.

Owing to the described embodiment of the at least one supply line, the effects of thermal expansion are particularly low. Such thermal expansions can in particular cause the beginning and end of the supply line to shift relative to each other in the vertical direction. The described embodiment of the supply line means that this change in height is distributed over a comparatively large length of the supply line and thus has a comparatively small effect on the supply line. In particular, the forces caused by the thermal expansion can be distributed particularly readily. This is based on the finding that a length of the supply line in the case of the described embodiment of the supply line is longer than in particular in the case of a direct rectilinear connection between distributor and cooling fluid inlet. This is particularly because of the opposite curvature in the first and second portions of the supply line.

It has been found that the advantages described are already achieved to an expedient extent if, when viewed in a projection onto a plane containing the axis of the reactor vessel, an orientation of the supply line in the first portion of the supply line changes by at least 135° over the course of the supply line and, in the second portion of the supply line, an orientation of the supply line changes by at least 45° over the course of the supply line. Since there is an oppositely directed curvature in the two portions, the supply line through the two portions together is bent by 90°. Compared to a simple 90° bend, however, the described supply line has a loop-like form. As a result, the length of the supply line is comparatively large. This allows the thermal expansion to be compensated for particularly readily.

The more the supply line deviates from the shape of a simple 90° bend, the greater a length of the supply line can be. Therefore, the described advantages are achieved to a greater extent the more the supply line changes its orientation in the first portion compared to in the second portion. It is therefore preferred that, when viewed in a projection onto a plane containing the axis of the reactor vessel, an orientation of the supply line in the course of the supply line changes by at least 150° in the first portion of the supply line and, in the second portion of the supply line, an orientation of the supply line changes over the course of the supply line by at least 60°. Even if the values of 150° and 60° are combined, the supply line through the two portions together is bent by 90°. This is also generally preferred. Thus, the supply line can be guided perpendicular to the shell wall of the reactor vessel on the shortest path without further curvature. In addition, this allows the supply line to meet the distributor vertically. This facilitates the attachment of the supply line to the distributor. In addition, the supply line can thus be attached to the distributor with a rectilinear pipe piece. A material separation can be arranged in this rectilinear pipe piece. This is advantageous in terms of the stress state because primarily axial forces instead of shearing forces act in a pipe piece parallel to the axis of the reactor vessel, in particular in comparison to a pipe piece which is arranged perpendicular to the axis of the reactor vessel.

Such a configuration also simplifies the further design of the supply line. It is therefore preferred that, when viewed in a projection onto a plane containing the axis of the reactor vessel, an orientation of the supply line in the first portion of the supply line changes by a first angle over the course of the supply line and, in the second portion of the supply line, an orientation of the supply line changes over the course of the supply line by a second angle, wherein the first angle is greater than the second angle by 60° to 120°, in particular by 90°. The first angle is at least 135°, in particular at least 150°. The second angle is at least 45°, in particular at least 60°.

Owing to the described configuration of the supply line, the effects of thermal expansions can be reduced particularly simply. This is especially true in comparison to flexible solutions with a flexible hose. The described supply line can be designed as a pipeline. Accordingly, the supply line can readily withstand even high pressures, which would not be the case, for example, with a hose. Preferably, the supply line is designed to be able to withstand a pressure of at least 100 bar.

In the present embodiment, the effect of thermal expansion can be compensated for particularly readily on the one hand by the described configuration of the discharge line in the upper region of the reactor vessel and on the other hand by the described configuration of the supply line in the lower region of the reactor vessel. The former is particularly advantageous in the case of the upright configuration presently under consideration, because the plate assembly expands thermally upwards. In the lower part of the reactor vessel, the thermal expansion is therefore of lesser importance. Nevertheless, it is also expedient to take this, albeit smaller, thermal expansion into account in the upright configuration. In the present embodiment, this can be done by the described configuration of the supply line.

In the first portion, the supply line does not have to be bent continuously as long as the previously specified definition, that an orientation of the supply line in the first portion of the supply line changes over the course of the supply line by at least 135°, preferably by at least 150°, is fulfilled. The first portion can also have a rectilinear partial portion. In the second portion, the supply line does not have to be bent continuously as long as the previously specified definition, that an orientation of the supply line in the second portion of the supply line changes over the course of the supply line by at least 45°, preferably by at least 60°, is fulfilled. The second portion can also have a rectilinear partial portion. In particular, it is possible that the first portion and/or the second portion forms a rectilinear region at a transition between the first portion and the second portion.

In another preferred embodiment of the reactor, the at least one supply line is formed with at least one rectilinear pipe piece and a plurality of curved pipe pieces.

The supply line could be formed by a single bending process. However, this would have to be carried out very precisely so that the beginning and end of the supply line have precisely the desired relative arrangement to each other when the supply line is completed. It is much simpler to assemble the supply line from a plurality of pipe pieces. By using at least one rectilinear pipe piece and a plurality of curved pipe pieces, the desired configuration of the supply line can be obtained.

The supply line of the present embodiment can be produced by holding the pipe pieces together and connecting them to one another, in particular by welding them together or flanging them on one another. This can be carried out as a multi-step process by means of which the supply line is gradually obtained. A new adjustment can be undertaken in each step. This can compensate again for any inaccuracy in previous steps.

In addition, it is advantageous if the individual pipe pieces are standard parts. Such pipe pieces are particularly easy to obtain and are inexpensive.

The curved pipe pieces can in particular have an elbow shape. Such a pipe piece is in the shape of a ring segment. The curved pipe piece is preferably curved by 30 to 180°, in particular by 90°. A pipe piece curved by 90° is in the shape of a quarter ring. In particular, such pipe pieces are available as standard parts.

In another preferred embodiment of the reactor, precisely one of the supply lines is provided, with all the flow paths running through the one supply line.

It was previously described that the reactor comprises at least one supply line, via which the distributor is connected to a respective cooling fluid inlet of the reactor vessel. In the present embodiment, this is the case by the reactor having precisely one such supply line. Each of the flow paths runs through this one supply line. The cooling fluid therefore always passes through this one supply line on the way from the cooling fluid inlet to the distributor.

The supply line is dimensioned in such a way that specifications regarding the flow rate and flow velocity of the cooling fluid through the supply line can be adhered to. These specifications can be selected in particular in such a way that the cooling fluid can be circulated in the cooling circuit without a pump. These specifications determine the line cross section which the supply line has to have. It has been found that this can already be carried out with a single supply line.

The requirements regarding the supply line(s) and the discharge line(s) differ. This is especially true if the cooling fluid flows through the supply line(s) in the liquid state and through the discharge line(s) in the gaseous state. The cooling fluid has a lower density in the gaseous state than in the liquid state. It may therefore be sufficient for there to be one supply line, even if two discharge lines are expedient. It is therefore preferable that there is precisely one supply line and at least two discharge lines.

In another preferred embodiment of the reactor, the at least one cooling fluid inlet is arranged spaced apart downwards from the distributor.

Owing to the described curvature of the supply line, such a distance between the cooling fluid inlet and distributor can be bridged particularly readily. If the distributor and cooling fluid inlet were at the same height, the supply line would have to have one or more further curved portions beyond the described curvature in the first and second portions in order to connect the distributor to the cooling fluid inlet. Although this is possible, it is not preferred.

If the discharge line and the supply line are designed as described, the advantages can be achieved equally with the upright and the suspending mounting of the plate assembly. It is therefore not necessary to restrict the reactor described to the upright mounting if both the discharge line and the supply line are designed as described. As a further aspect of the invention, a reactor is therefore presented, which comprises a reactor vessel and which comprises inside the reactor vessel:
a plate assembly which is formed by a plurality of cooling plates through which a cooling fluid can flow, wherein between the cooling plates intermediate spaces, in which a catalyst is arranged, are formed such that a reaction gas can flow through the intermediate spaces and come into contact with the catalyst,
a distributor which is attached to the plate assembly on an underside of the plate assembly,
at least one supply line, via which the distributor is connected to a respective cooling fluid inlet of the reactor vessel,
a collector which is attached to the plate assembly on a top side of the plate assembly,
at least one discharge line, via which the collector is connected to a respective cooling fluid outlet of the reactor vessel,

flow paths for the cooling fluid being formed, the flow paths in each case leading from one of the cooling fluid inlets through the corresponding supply line, the distributor, one of the cooling plates, the collector and one of the discharge lines to the corresponding cooling fluid outlet, and wherein the at least one discharge line is curved in such a way that the discharge line runs around an axis of the reactor vessel by at least 180°, and wherein the at least one supply line is curved in such a way that, when viewed in a projection onto a plane containing the axis of the reactor vessel, an orientation of the supply line in a first portion of the supply line changes over the course of the supply line by at least 135°, preferably by at least 150°, and in a second portion of the supply line, which is connected to the first portion in the direction of the distributor, an orientation of the supply line changes over the course of the supply line by at least 45°, preferably by at least 60°, and wherein the at least one supply line in the first portion is curved in the opposite direction to the second portion.

The described advantages and features of the reactor described above are applicable and transferable to the reactor described herein, and vice versa. In the reactor described here, the plate assembly can be mounted upright or in suspended form. Another type of mounting is also conceivable here.

As another aspect of the invention, a method is presented for producing a reactor designed as described. The method comprises
a) providing the reactor vessel, the plate assembly, the distributor, the at least one supply line, the collector and the at least one discharge line,
b) mounting the reactor vessel, the plate assembly, the distributor, the at least one supply line, the collector and the at least one discharge line for the reactor,

wherein the at least one discharge line in step a) is provided by the following sub-step:
a1) producing the at least one discharge line by holding a plurality of pipe pieces together and connecting them to one another, in particular by welding them together or flanging them on one another.

The described advantages and features of the reactor are applicable and transferable to the method, and vice versa. The reactor is preferably produced by the described method.

It is particularly preferred in the method that the at least one discharge line is formed with a plurality of rectilinear pipe pieces and at least one curved pipe piece. In this case, in particular, standard parts can be used as pipe pieces. However, the shape of the pipe pieces does not matter for the described method.

In step a1), the discharge line can be obtained gradually. This refers in particular to the fact that the pipe pieces are connected to one another sequentially, in particular are welded together or flanged on one another. Holding them together can also be undertaken sequentially. Thus, a further pipe piece is always held on the already produced part of the discharge line and connected to the already produced part of the discharge line, in particular welded together or flanged on one another. However, it is also possible to hold a plurality of or even all the pipe pieces together and only then to weld them together. It does not matter in which order the individual welded joints are formed. The holding together can be undertaken manually or by means of holding devices. The holding together can be assisted by the fact that adjacent pipe pieces are provisionally connected to one another by individual welding points. This may also be referred to as tacking.

In a preferred embodiment of the method, the at least one supply line in step a) is provided by the following sub-step:
a2) producing the at least one supply line by holding a plurality of pipe pieces together and connecting them to one another, in particular by welding them together or flanging them on one another.

For step a2), what has been said with regard to step a1) applies correspondingly.

### BRIEF DESCRIPTION OF THE DRAWINGS

The invention will be explained in more detail below with reference to the figures. The figures show a particularly preferred exemplary embodiment; however, the invention is not limited thereto. The figures and the size relationships presented therein are only schematic. In the figures:

FIG. 1 shows a reactor according to the invention in a lateral sectional view,

FIG. 2a shows the collector and the discharge lines of the reactor from FIG. 1,

FIG. 2b shows a view of the collector and the discharge lines of the reactor from FIG. 1,

FIG. 2c shows another view of the collector and the discharge lines of the reactor from FIG. 1,

FIG. 2d shows another view of the collector and the discharge lines of the reactor from FIG. 1,

FIG. 3 shows the distributor and the supply line of the reactor from FIG. 1.

### DETAILED DESCRIPTION OF PREFERRED EMBODIMENTS

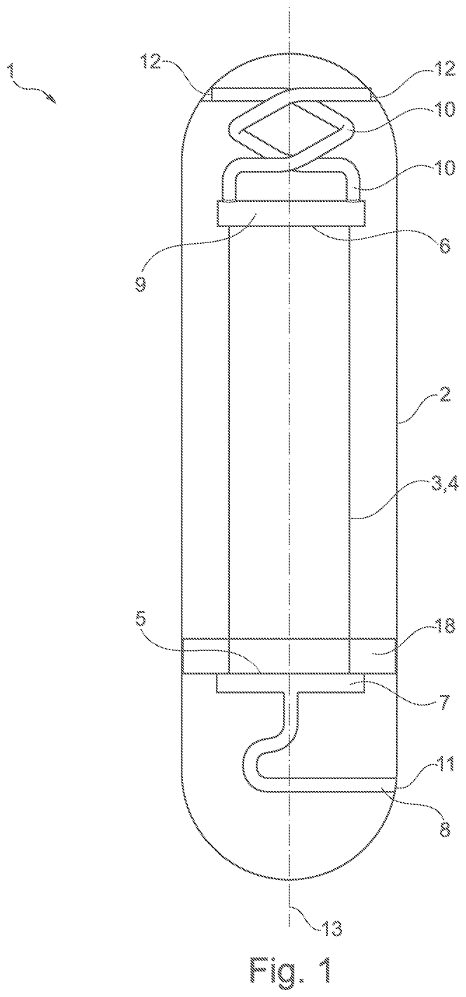

FIG. 1 shows a reactor 1 with a reactor vessel 2. Inside the reactor vessel 2, the reactor 1 has a plate assembly 3 mounted upright. The upright mounting of the plate assembly 3 is indicated by a support 18 on an underside 5 of the plate assembly 3. The plate assembly 3 is formed by a plurality of cooling plates 4. One of the cooling plates 4 can be seen in FIG. 1. The remaining cooling plates 4 are arranged parallel thereto within the drawing plane. Between the cooling plates 4 intermediate spaces, in which a catalyst is arranged, are formed such that a reaction gas can flow through the intermediate spaces and come into contact with the catalyst. The reaction gas can, for example, be introduced into the reactor vessel 2 through an inlet (not shown) below the plate assembly 3, the flow flowing through the intermediate spaces from the bottom to the top and being discharged from the reactor vessel 2 at an outlet (not shown) above the plate assembly 3. While the reaction gas flows through the intermediate spaces between the cooling plates 4, it can be cooled by the cooling plates. For this purpose, the cooling plates 4 are designed for a cooling fluid to flow through them.

In order for the cooling fluid to be able to flow through the cooling plates 4, the reactor 1 has the following elements inside the reactor vessel 2:
a distributor 7 which is attached to the plate assembly 3 on an underside 5 of the plate assembly 3,
a supply line 8, via which the distributor 7 is connected to a cooling fluid inlet 11 of the reactor vessel 2,
a collector 9 which is attached to the plate assembly 3 on a top side 6 of the plate assembly 3,
two discharge lines 10, via which the collector 9 is connected to a respective cooling fluid outlet 12 of the reactor vessel 2.

Flow paths for the cooling fluid are thus formed, the flow paths in each case leading from the cooling fluid inlet 11 through the supply line 8, the distributor 7, one of the cooling plates 4, the collector 9 and one of the discharge lines 10 to the corresponding cooling fluid outlet 12. In each case only a portion of the flow paths runs through each of the two discharge lines 10. The two cooling fluid outlets 12 are each spaced apart upwards from the collector 9.

The cooling fluid can be conducted via these flow paths from the cooling fluid inlet 11 to one of the two cooling fluid outlets 12 through the interior of the reactor vessel 2. In this way, the cooling fluid is separated from the remaining interior of the reactor vessel 2, in which the reaction gas can flow. The cooling fluid thus does not come into contact with the reaction gas. It is only possible to exchange heat between the cooling fluid and the reaction gas.

Furthermore, an axis 13 of the reactor vessel 2 is shown in FIG. 1.

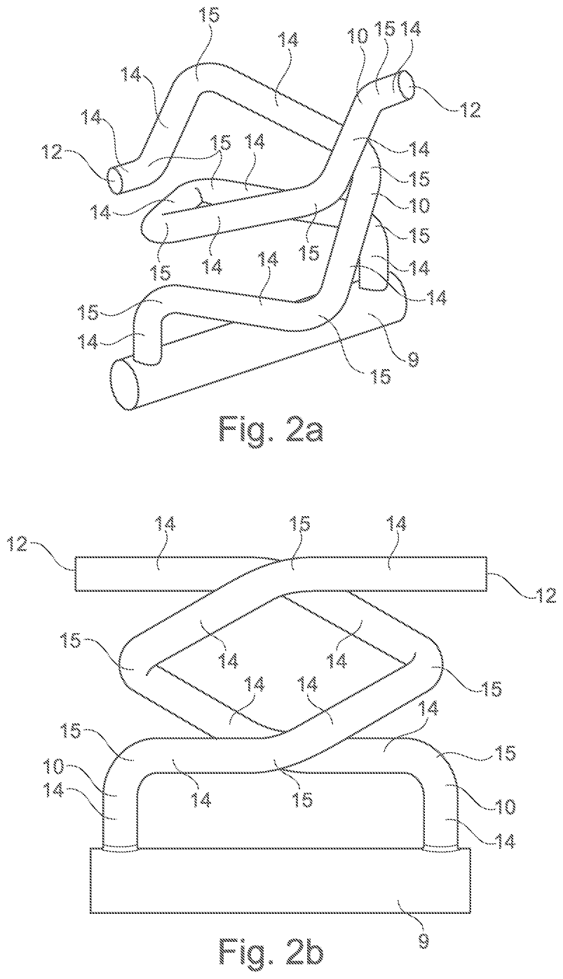

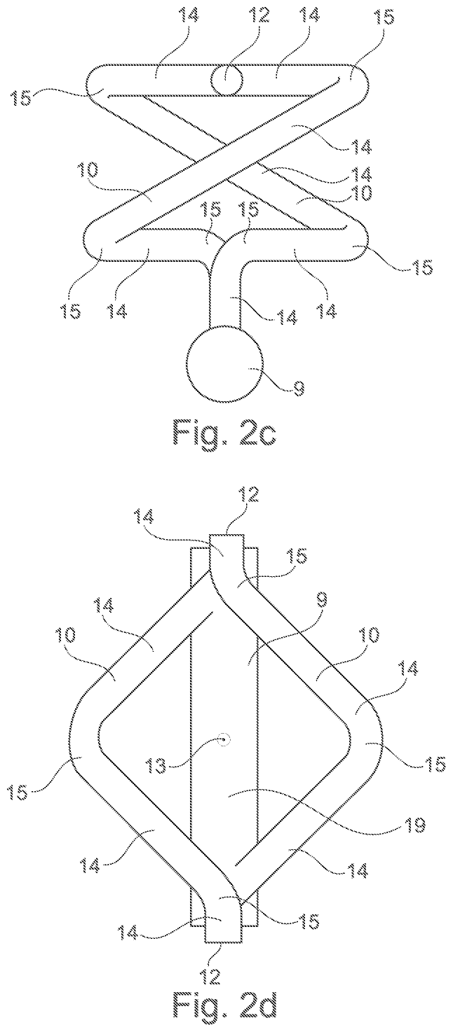

In FIGS. 2a to 2d, the collector 9 and the two discharge lines 10 of the reactor 1 are shown in enlarged form. FIG. 2a shows a perspective view. FIG. 2b shows a lateral view from the same perspective as FIG. 1. FIG. 2c shows a lateral view rotated with respect thereto by 90°. FIG. 2d shows a top view.

It can be seen from FIGS. 2a to 2d that the two discharge lines 10 are respectively curved in such a way that the discharge lines 10 each run around the axis 13 of the reactor vessel 2 by 360°. This can be seen in particular by way of the perspective illustration of FIG. 2a and by way of the top view of FIG. 2d. In the view shown in FIG. 2d perpendicular to the axis 13 of the reactor vessel 2, an orientation of the respective discharge line 10 changes over the course of this discharge line 10 by about 360°.

It can also be seen from FIGS. 2a to 2d that the two discharge lines 10 are each formed with a plurality of rectilinear pipe pieces 14 and a plurality of curved pipe pieces 15. The two discharge lines 10 are curved in the same direction and are attached offset from each other to the collector 9. The two discharge lines 10 can each be produced by holding the pipe pieces 14, 15 together and connecting them to one another, in particular by welding them together or flanging them on one another.

In particular by way of the top view of FIG. 2d it can be seen that the two discharge lines 10 each leave open a clearance 19 around the axis 13 of the reactor vessel 2.

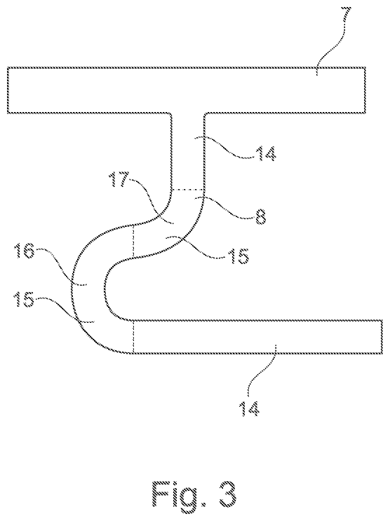

FIG. 3 shows a lateral illustration of the distributor 7 and the supply line 8 from FIG. 1. The perspective of FIG. 3 is the same as in FIG. 1. The course of the supply line 8 which can be seen in FIG. 3 corresponds to the course of the supply line 8, when viewed in a projection onto a plane containing the axis 13 of the reactor vessel 2. It can be seen that the supply line 8 is curved in such a way that an orientation of the supply line 8 in a first portion 16 of the supply line 8 changes over the course of the supply line 8 by 180°, and, in a second portion 17 of the supply line 8, which adjoins the first portion 16 in the direction of the distributor 7, an orientation of the supply line 8 changes over the course of the supply line 8 by 90°. In the first portion 16, the supply line is curved in the opposite direction to the second portion 17. The extent of the first portion 16 and of the second portion 17 is in each case indicated by a dashed line. The supply line 2 is also formed with a plurality of rectilinear pipe pieces 14 and a plurality of curved pipe pieces 15. The supply line 8 can be produced by holding the pipe pieces 14, 15 together and connecting them to one another, in particular by welding them together or flanging them on one another.

### LIST OF REFERENCE SYMBOLS

1 reactor
2 reactor vessel
3 plate assembly
4 cooling plate
5 underside
6 top side
7 distributor
8 supply line
9 collector
10 discharge line
11 cooling fluid inlet
12 cooling fluid outlet
13 axis
14 rectilinear pipe piece
15 curved pipe piece
16 first portion
17 second portion
18 support
19 clearance

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A reactor comprising a reactor vessel and, inside the reactor vessel:
a plate assembly which is mounted upright and which is formed by a plurality of cooling plates through which a cooling fluid can flow, wherein between the cooling plates intermediate spaces, in which a catalyst is arranged, are formed such that a reaction gas can flow through the intermediate spaces and come into contact with the catalyst,
a distributor which is attached to the plate assembly on an underside of the plate assembly,
at least one supply line, via which the distributor is connected to a respective cooling fluid inlet of the reactor vessel,
a collector which is attached to the plate assembly on a top side of the plate assembly,
at least one discharge line, via which the collector is connected to a respective cooling fluid outlet of the reactor vessel,
wherein flow paths for the cooling fluid are formed, the flow paths in each case leading from one of the cooling fluid inlets through the corresponding supply line, the distributor, one of the cooling plates, the collector and one of the discharge lines to the corresponding cooling fluid outlet, and wherein the at least one discharge line is curved in such a way that the discharge line runs around an axis of the reactor vessel by at least 180°.

2. The reactor according to claim 1, wherein the at least one discharge line is formed with a plurality of rectilinear pipe pieces and at least one curved pipe piece.

3. The reactor according to claim 1, comprising a plurality of the discharge lines, wherein in each case only a portion of the flow paths runs through each of the discharge lines.

4. The reactor according to claim 3, wherein the at least two discharge lines are curved in the same direction and are attached offset from one another to the collector.

5. The reactor according to claim 1, wherein the at least one cooling fluid outlet is arranged spaced apart upwards from the collector.

6. The reactor according to claim 1, wherein the at least one discharge line leaves a clearance free around the axis of the reactor vessel.

7. The reactor according to claim 1, wherein the at least one supply line is curved in such a manner that, when viewed in a projection onto a plane containing the axis of the reactor vessel, an orientation of the supply line in a first portion of the supply line changes over the course of the supply line by at least 135°, and in a second portion of the supply line, which adjoins the first portion in the direction of the distributor, an orientation of the supply line changes over the course of the supply line by at least 45°, and wherein the at least one supply line is curved in the first portion in the opposite direction to the second portion.

8. A method for producing a reactor according to claim 1, comprising:
a) providing the reactor vessel, the plate assembly, the distributor, the at least one supply line, the collector and the at least one discharge line,
b) mounting the reactor vessel, the plate assembly, the distributor, the at least one supply line, the collector and the at least one discharge line for the reactor,
wherein the at least one discharge line in step a) is provided by the following sub-step:
a1) producing the at least one discharge line by holding a plurality of pipe pieces together and connecting them to one another.

9. The method according to claim 8, wherein the at least one supply line in step a) is provided by the following sub-step:
a2) producing the at least one supply line by holding a plurality of pipe pieces together and connecting them to one another.
